(19) United States
(12) Patent Application Publication
(10) Pub. No.: US 2012/0054010 A1
(43) Pub. Date: Mar. 1, 2012

(54) TARGETING CONSUMERS BY PAYING USERS TO SHARE ONLINE COUPONS

(76) Inventors: Brian Bouta, Santa Clara, CA (US); Arun Sundaresan, San Jose, CA (US)

(21) Appl. No.: 12/868,579

(22) Filed: Aug. 25, 2010

(51) Int. Cl. G06Q 30/00

(52) U.S. Cl. 705/14.16

(57) ABSTRACT

A method and a system are provided for targeting consumers by paying users to share online coupons. In one example, the system provides, to a user device, one or more coupons that each include functionality for performing a sharing operation. The system receives notification of a coupon being selected for sharing. The notification is a result of a user selecting a sharing operation in the coupon. The system receives, from a referring user, a list of one or more referred users. The list of one or more referred users includes users with which the referring user intends to share a coupon. The system formats the coupon into a referred coupon having an identifier that is associated with one or more referring users, as well as one or more referred users. The system shares the referred coupon with one or more referred users.

### FIELD OF THE INVENTION

The invention relates to sharing online coupons. More particularly, the invention relates to targeting consumers by paying users to share online coupons.

### BACKGROUND

An advertiser, such as Ford™ or McDonald's™, generally contracts a creative agency for ads to be placed in various media for the advertiser's products. Such media may include TV, radio, Internet ads (e.g., sponsored search ads, banner display ads, textual ads, streaming ads, mobile phone ads, etc.) or print medium ads (e.g., ads in newspapers, magazines, posters, etc.). The advertiser may engage one or more creative agencies that specialize in generating ads for one or more of the above media. A company wants to show the most relevant ads to end users in order to get the most value from their ad campaign.

Coupons are commonly distributed for promoting products and services. Despite the obvious benefits of coupons, a vast majority of purchasers fail to utilize coupons due to the tedious process of manually sifting through ads, clipping desirable coupons, and saving them. Moreover, many customers that do undergo this process often fail to utilize saved coupons at the time of purchase. For instance, customers commonly forget to bring coupons with them and some even forget about the coupons entirely. Furthermore, since coupons do not provide any means for reminding customers to use them, customers frequently fail to use coupons prior to the expiration date.

### SUMMARY

What is needed is an improved method having features for addressing the problems mentioned above and new features not yet discussed. Broadly speaking, the invention fills these needs by providing a method and a system for targeting consumers by paying users to share online coupons.

In a first embodiment, a computer-implemented method is provided for sharing coupons. The method comprises the following: providing, to a user device, one or more coupons that each include functionality for performing a sharing operation; receiving, at a computer, notification of a coupon being selected for sharing, wherein the notification is a result of a user selecting a sharing operation in the coupon; receiving, from a referring user, a list of one or more referred users, wherein the list of one or more referred users includes users with which the referring user intends to share a coupon; formatting the coupon into a referred coupon having an identifier that is associated with one or more referring users, as well as one or more referred users; and sharing the referred coupon with one or more referred users.

In a second embodiment, a system is provided for sharing online coupons. The system comprises a computer system configured for the following: providing, to a user device, one or more coupons that each include functionality for performing a sharing operation; receiving, at a computer, notification of a coupon being selected for sharing, wherein the notification is a result of a user selecting a sharing operation in the coupon; receiving, from a referring user, a list of one or more referred users, wherein the list of one or more referred users includes users with which the referring user intends to share a coupon; formatting the coupon into a referred coupon having an identifier that is associated with one or more referring users, as well as one or more referred users; and sharing the referred coupon with one or more referred users.

In a third embodiment, a computer readable medium is provided comprising one or more instructions for sharing online coupons. The one or more instructions are configured for causing one or more processors to perform at least the following steps: providing, to a user device, one or more coupons that each include functionality for performing a sharing operation; receiving, at a computer, notification of a coupon being selected for sharing, wherein the notification is a result of a user selecting a sharing operation in the coupon; receiving, from a referring user, a list of one or more referred users, wherein the list of one or more referred users includes users with which the referring user intends to share a coupon; formatting the coupon into a referred coupon having an identifier that is associated with one or more referring users, as well as one or more referred users; and sharing the referred coupon with one or more referred users.

The invention encompasses other embodiments configured as set forth above and with other features and alternatives. It should be appreciated that the invention may be implemented in numerous ways, including as a method, a process, an apparatus, a system or a device.

### BRIEF DESCRIPTION OF THE DRAWINGS

The invention will be readily understood by the following detailed description in conjunction with the accompanying drawings. To facilitate this description, like reference numerals designate like structural elements.

FIG. 1 is a high-level block diagram of a system for sharing online coupons, in accordance with some embodiments;

FIG. 2 illustrates coupons embedded in a Web page 200, in accordance with some embodiments;

FIG. 3 shows another example of a Web page that includes coupons depicted as ranked results, in accordance with some embodiments;

FIG. 4 shows another example of a coupon in another display format, in accordance with some embodiments;

FIG. 5 is a schematic diagram of a share function of a coupon, in accordance with some embodiments;

FIG. 6 shows an original coupon that is in a transaction format that is suitable for tracking the original coupon, in accordance with some embodiments;

FIG. 7 shows a shared coupon that is in a transaction format that is suitable for tracking the shared coupon, in accordance with some embodiments;

FIG. 8 is an example user device that is displaying icons for applications of a Web portal system, in accordance with some embodiments;

FIG. 9 is an example user device that is displaying an interface for a coupons application of a Web portal system, in accordance with some embodiments;

FIG. 10 is an example user device that is displaying a coupon, in accordance with some embodiments;

FIG. 11 is a schematic diagram of a system for paying users to share coupons, in accordance with some embodiments;

FIG. 12 is a flowchart of a method for sharing online coupons, in accordance with some embodiments; and

FIG. 13 is a diagrammatic representation of a network, including nodes that may comprise a machine within which a set of instructions may be executed, in accordance with some embodiments.

### DETAILED DESCRIPTION

An invention is disclosed for a method and a system for targeting consumers by paying users to share online coupons. Numerous specific details are set forth in order to provide a thorough understanding of the invention. It will be understood, however, to one skilled in the art, that the invention may be practiced with other specific details.

### DEFINITIONS

Some terms are defined below in alphabetical order for easy reference. These terms are not rigidly restricted to these definitions. A term may be further defined by the term's use in other sections of this description.

“Ad” (e.g., ad, item and/or message) means a paid announcement, as of goods or services for sale, preferably on a network, such as the Internet. An ad may also be referred to as an ad, an item and/or a message.

“Ad click-through rate” (e.g., click-through rate) means a measurement of ad clicks per time.

“Ad server” is a server that is configured for serving one or more ads to user devices. An ad server is preferably controlled by a publisher of a Web site and/or an advertiser of online ads. A server is defined below.

“Advertiser” (e.g., messenger and/or messaging customer, etc.) means an entity that is in the business of marketing a product and/or a service to users. An advertiser may include without limitation a seller and/or a third-party agent for the seller. An advertiser may also be referred to as a messenger and/or a messaging customer. Advertising may also be referred to as messaging.

“Advertising” means marketing a product and/or service to one or more potential consumers by using an ad. One example of advertising is publishing a sponsored search ad on a Web site.

“Application server” is a server that is configured for running one or more devices loaded on the application server. For example, an application server may run a device configured for deducing shadow profiles.

“Click” (e.g., ad click) means a selection of an ad impression by using a selection device, such as, for example, a computer mouse or a touch-sensitive display.

“Client” means the client part of a client-server architecture. A client is typically a user device and/or an application that runs on a user device. A client typically relies on a server to perform some operations. For example, an email client is an application that enables a user to send and receive e-mail via an email server. The computer running such an email client may also be referred to as a client.

“Conversion” (e.g., ad conversion) means a purchase of a product/service that happens as a result of a user responding to an ad and/or coupon.

“Coupon” (e.g., coupon ad) means a portion of a certificate, ticket, label, ad, or the like, set off from the main body by dotted lines or the like to emphasize its separability, entitling the holder to something, as a gift or discount, or for use as an order blank, a contest entry form, etc. A coupon is designed in a convenient format for a user to take the coupon to a seller to receive an advertised benefit.

“Database” (e.g., database system, etc.) means a collection of data organized in such a way that a computer program may quickly select desired pieces of the data. A database is an electronic filing system. In some instances, the term “database” is used as shorthand for “database management system”. A database may be implemented as any type of data storage structure capable of providing for the retrieval and storage of a variety of data types. For instance, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” means hardware, software or a combination thereof. A device may sometimes be referred to as an apparatus. Examples of a device include without limitation a software application such as Microsoft Word™, a laptop computer, a database, a server, a display, a computer mouse and/or a hard disk.

“Impression” (e.g., ad impression) means a delivery of an ad to a user device for viewing by a user.

“Item” means an ad, which is defined above.

“Marketplace” means a world of commercial activity where products and/or services are browsed, bought and/or sold, etc. A marketplace may be located over a network, such as the Internet. A marketplace may also be located in a physical environment, such as a shopping mall.

“Message” means an ad, which is defined above.

“Messaging” means advertising, which is defined above.

“Messenger” means an advertiser, which is defined above.

“Network” means a connection, between any two or more computers, that permits the transmission of data. A network may be any combination of networks, including without limitation the Internet, a local area network, a wide area network, a wireless network and a cellular network.

“Publisher” means an entity that publishes, on a network, a Web page having content and/or ads, etc.

“Server” means a software application that provides services to other computer programs (and their users), in the same computer or another computer. A server may also refer to the physical computer that has been set aside to run a specific server application. For example, when the software Apache HTTP Server is used as the Web server for a company's Web site, the computer running Apache may also be called the Web server. Server applications may be divided among server computers over an extreme range, depending upon the workload.

“Social network” means a networked software application having user accounts (e.g., nodes) that are coupled by using one or more interdependencies, such as, for example, friendship, kinship, common interest, financial exchange, dislike, sexual relationship, beliefs, knowledge and/or prestige. Examples of a social network include without limitation Facebook™, Twitter™, Myspace™, Delicious™, Digg™, and/or Stumble Upon™.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“System” means a device or multiple coupled devices. A device is defined above.

“User” (e.g., consumer, etc.) means an operator of a user device. A user is typically a person who seeks to acquire a product and/or service. For example, a user may be a woman who is browsing Yahoo!™ Shopping for a new cell phone to replace her current cell phone. The term “user” may refer to a user device, depending on the context.

“User device” (e.g., computer, user computer, client and/or server, etc.) means a single computer or to a network of interacting computers. A user device is a computer that a user may use to communicate with other devices over a network, such as the Internet. A user device is a combination of a hardware system, a software operating system and perhaps one or more software application programs. Examples of a user device include without limitation a laptop computer, a palmtop computer, a smart phone, a cell phone, a mobile phone, an IBM-type personal computer (PC) having an operating system such as Microsoft Windows™, an Apple™ computer having an operating system such as MAC-OS, hardware having a JAVA-OS operating system, and a Sun Microsystems Workstation having a UNIX operating system.

“Web browser” means a software program that may display text, graphics, or both, from Web pages on Web sites. Examples of a Web browser include without limitation Mozilla Firefox™ and Microsoft Internet Explorer™.

“Web page” means documents written in a mark-up language including without limitation HTML (hypertext mark-up language), VRML (virtual reality modeling language), dynamic HTML, XML (extended mark-up language) and/or other related computer languages. A Web page may also refer to a collection of such documents reachable through one specific Internet address and/or through one specific Web site. A Web page may also refer to any document obtainable through a particular URL (Uniform Resource Locator).

“Web portal” (e.g., public portal) means a Web site or service that offers a broad array of resources and services, such as, for example, e-mail, forums, search engines, and online shopping malls. The first Web portals were online services, such as AOL, that provided access to the Web. However, now, most of the traditional search engines (e.g., Yahoo!™) have transformed themselves into Web portals to attract and keep a larger audience.

“Web server” is a server configured for serving at least one Web page to a Web browser. An example of a Web server is a Yahoo!™ Web server. A server is defined above.

“Web site” means one or more Web pages. A Web site preferably includes plurality of Web pages, virtually connected to form a coherent group.

### General Overview

Serving well-targeted ads to users is a challenge facing Web portal systems, such as Yahoo!™. Even if a user is served an ad that is useful, the user is not necessarily motivated to share the ad with friends. Users are more likely to share deals with friends if there is a financial incentive to do so. Conversions are much more valuable than impressions or clicks, sometimes by several orders of magnitude. If a Web portal system (e.g., Yahoo!™) can award users for helping to better target ads by sharing coupons with friends, then the users receiving those coupons may be more likely to use them in offline transactions. The result is more conversions and more revenue for the Web portal system.

The description below provides a system configured for performing the following: sharing coupons; formatting coupons for tracking purposes; and paying users who shared coupons that underwent a conversion.

### Architecture Overview

The advent of the Internet eases many of the problems associated with conventional coupons, as the practice of serving coupons through Internet-based advertising has become increasingly popular among advertisers. Online ads may comprise banner ads, links to Web pages, images, audio and/or video, animations, two- and three-dimensional objects, etc.

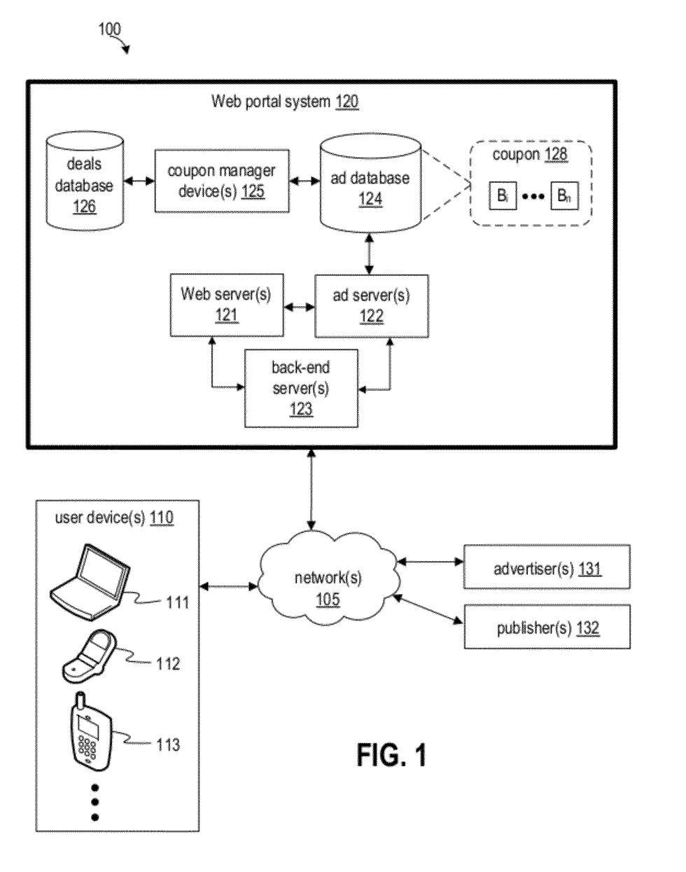

FIG. 1 is a high-level block diagram of a system 100 for sharing online coupons, in accordance with some embodiments. The one or more networks 105 couple together a Web portal system 120, one or more user devices 110, one or more advertisers 131, and one or more publishers 132. The network 105 may be any combination of networks, including without limitation the Internet, a local area network, a wide area network, a wireless network and/or a cellular network.

Each user device 110 includes without limitation a single computer or a network of interacting computers. Examples of a user device include without limitation a laptop computer 111, a cell phone 112 and a smart phone 113. A user may communicate with other devices over the network 105 by using a user device 110. A user may be, for example, a person browsing or shopping in a marketplace on the Internet.

The Web portal system 120 performs important operations of the system 100 and is described further below in other sections. An example of a Web portal system 120 is operated by Yahoo!™. The Web portal system 120 may include without limitation the following: one or more Web servers 121, one or more ad servers 122, and one or more back-end servers 123, an ad database 124, a coupon manager device 125, and a deals database 126. The Web server 121 is coupled to the ad server 122 and the back-end server 123. The ad server 122 is coupled to the back-end server. The ad server 122 is coupled to the ad database 124.

The coupon manager device 125 preferably includes an application server that is coupled to the deals database and the ad database 124. While the coupon manager device 125 is shown in FIG. 1 as a component of the Web portal system 120, those of skill in the art will appreciate that the coupon manager device 125 may be remotely coupled to the Web portal system 120 via a network, and/or may be controlled by a separate entity (e.g., an advertising agency).

The Web portal system 120 is configured with programs, algorithms, applications, software, graphical user interfaces, models, other tools and/or other procedures necessary to implement and/or facilitate methods and systems according to embodiments of the invention, or computerized aspects thereof, whether on one computer or distributed among multiple computers or devices. These include local and global adjustment, decision making, or optimizations, weighting, pricing, allocation, scheduling, serving, and/or other techniques. In various embodiments, the elements of the Web portal system 120 may exist on one computer, or may exist on multiple computers, devices and/or locations.

The ad server 122 may be directly incorporated in the Web portal system 120, remotely coupled to the Web portal system 120 via the one or more networks 105, and/or controlled by a separate entity (e.g., a third party ad network). The ad servers 122 are configured for serving one or more ads to the user devices 110. The one or more ad servers 122 are preferably controlled by an advertiser 131 of online ads and/or a publisher 132 of a Web site. An advertiser 131 is an entity that is seeking to market a product and/or a service to users at the user devices 110. A publisher 132 is an entity that publishes, over the network 105, a Web page having content and/or ads. Examples of an advertiser 131 and/or a publisher 132 include without limitation Amazon.com™, Nike™ and Yahoo!™.

The Web portal system 120 is configured for communicating with one or more advertisers 131 and one or more publishers 132. The Web portal system 120 is further configured for communicating with the one or more user devices 110 and for serving at least one Web page to a Web browser on a user device 110.

The configuration of the system 100 in FIG. 1 is for explanatory purposes. For example, in some embodiments, the ad servers 122 may be part of an ad exchange. For example, some Web portals operate, utilize, or facilitate advertising exchanges. Such exchanges may virtually connect parties including advertisers, publishers, networks of advertisers, networks of publishers, and other entities. The exchange may facilitate arrangements, bidding, auctioning in connection with ads and ad campaigns, and may also facilitate planning and serving of ads. Ads that may be included within the exchange may include display or graphical ads that are not served in connection with user searches including keyword-based searches. The exchange may also include sponsored search ads, including ads served in association with user searches, such as keyword searches. Any type of simple or sophisticated ads may be included, such as text, graphic, picture, video and audio ads, streaming ads, interactive ads, rich media ads, etc.

In some embodiments, active ads are ads that are available for serving on or in connection with the exchange, whereas non-active ads are not so available. For example, non-active ads may include ads that are in review prior to be available for serving. This may include review as part of an editorial process to try to ensure or reduce the chance that inappropriate or dangerous ads are not allowed to be active. There are numerous other configurations in other embodiments that are possible.

### Sharing Coupons

Referring to FIG. 1, user devices 110, communicatively coupled to a network 105, such as the Internet, are capable of accessing various Web sites that may display ads. For example, a user device 110 may submit a search request comprising one or more terms to a search engine of the Web portal system 120. Upon receiving the search request, the search engine retrieves a Web page comprising links to content, as well as ads that may be related to the search terms provided by the user device 110. The search engine generates and sends search results to the user device 110, which may then select or view items in the search results, including one or more ads. The ads displayed in the search results on the user devices 110 typically generate revenue for the Web portal system 120.

Despite the increasing popularity of online advertising and the relative simplicity in which users may take advantage of ad offers, advertisers continue to seek improvements to enhance the overall effectiveness of online advertising. For instance, it is common for an Internet user to ignore an ad, especially one considered irrelevant or of little use to the user. However, the Web portal system 120 (e.g., Yahoo!™) is configured for having a solution to this problem.

The Web portal system 120 is configured for managing the sharing of online coupons. The one or more advertisers 131 may generate coupons and send the coupons to the Web portal system 120. The Web portal system may then serve the coupons to the one or more user devices 110.

In one embodiment, an advertiser 131 may submit a coupon as an electronic file specifying the content of the coupon. The electronic file may contain text specifying the details of the coupon, graphics, and any other content specified by the electronic file. For instance, the electronic file may also include information such as, but not limited to, an identifier (e.g., a coupon serial number) or a barcode for tracking the coupon, an expiration date, a hyperlink to the coupon provider's Web site, contact information, etc.

The coupon manager device 125 is configured for managing and/or generating coupons. The deals database 126 is configured for storing the coupons. In some embodiments, the coupons are submitted by the advertisers 131. The coupon manager device 125 is configured for incorporating one or more deals stored in the deals database into one or more coupons 128 to be sent for display on one or more user devices 110 as part of a Web page. More specifically, the coupon manager device 125 utilizes the content contained in an electronic coupon file and incorporates the content into an ad code, which may be saved as an executable file. When the ad code is executed, an electronic coupon is displayed to a user device 110 in the form of an online coupon 128. The ad code may include instructions written in any suitable human-readable computer programming language.

The coupon manager device 125 is further configured to include code to generate within the coupon 128 a set of interactive components, such as, for example, buttons B₁ through Bₙ, where n is a positive integer. Accordingly, the coupon manager device 125 may incorporate multimedia object technologies (e.g., Java™, Shockwave™, Flash™, etc.) for providing interactive buttons with various functionalities. As will be described in greater detail below, each coupon 128 is embedded with at least a “share” button. Upon generating a coupon 128 for a coupon stored in the deals database 126, the coupon manager device 125 stores the coupon 128 in a storage unit such as an ad database 124.

The ad server 122 is operable to support multiple advertising formats, such as, for example, BMP, TIFF, GIF, JPEG, and Flash formats. The ad server 122 may be a hardware and/or software module configured to search the ad database 124 and retrieve one or more ads 400 for sending to a user device 110.

The Web servers 121 and/or back-end servers 123 are configured for retrieving a Web page in response to a search request initiated by a user device 110. The ad server 122 may be configured for embedding an appropriate coupon 128 in a Web page retrieved by a Web server 121 and/or a back-end server 123. While the back-end server 123 is shown in FIG. 1 as being part of the Web portal system 120, in other embodiments the back-end server 123 may be a separate component remotely coupled to the Web portal system 120.

The ad server 122 may select ads 400 based on a variety of factors, such as time, demographics, category, content, etc. In addition, the ad server 122 may select a coupon 128 based on a corresponding expected revenue. For example, expected revenue for a given coupon 128 may be calculated according to a historical click-through rate associated with the coupon 128. It is to be understood, however, that the ad server 122 may select ads 400 using various algorithms and techniques known to those of ordinary skill in the art.

In one embodiment, the ad server 122 may select a coupon 128 based on a user's profile and/or behavior. For instance, a Web page displaying a given coupon 128 may include a tracking object configured for monitoring user activity. Alternatively, the coupon manager device 125 may be configured for embedding a tracking object in the coupon 128 itself. A tracking object may include a component such as an applet program written in an interpretive language such as Java™. Similarly, a tracking object may include a program written in scripting language such as JavaScript™ to track and gather user activity. As will be understood to those of skill in the art, a Java applet and a JavaScript code embedded in a Web page or coupon 128 may be used collectively to gather user data.

The tracking object is operable to obtain information such as metadata regarding a user's behavior and/or profile by tracking user interaction with a user device and/or by collecting information stored within a user device. Such user-related information may include a user's Internet Protocol (IP) address, geographic location, nature or theme of the Web site on which a coupon 128 is being displayed, the nature of the specific content viewed at a user device 110, the user device's Web browsing history or patterns, as well as other psychographic data about the user associated with the user device. The psychographic data may be received from a number of different sources. Information may also be collected about the user's age, location, gender, income, education, ethnicity, product preferences, and a variety of other demographic characteristics that are useful in matching an ad to a user of a user device 110. The Web portal system 120 is not limited to the use of a tracking object as described above, as the system may implement any suitable technique for gathering user information.

The back-end server 123 is configured for receiving user-related data from the tracking object and for transmitting the data to the ad server 122. In another aspect, the back-end server 123 is configured for communicating user-related data with the Web server 121, which may then communicate the data with the ad server 122. In either implementation, however, the ad server 122 may select a coupon 128 based on data obtained from the back-end server 123.

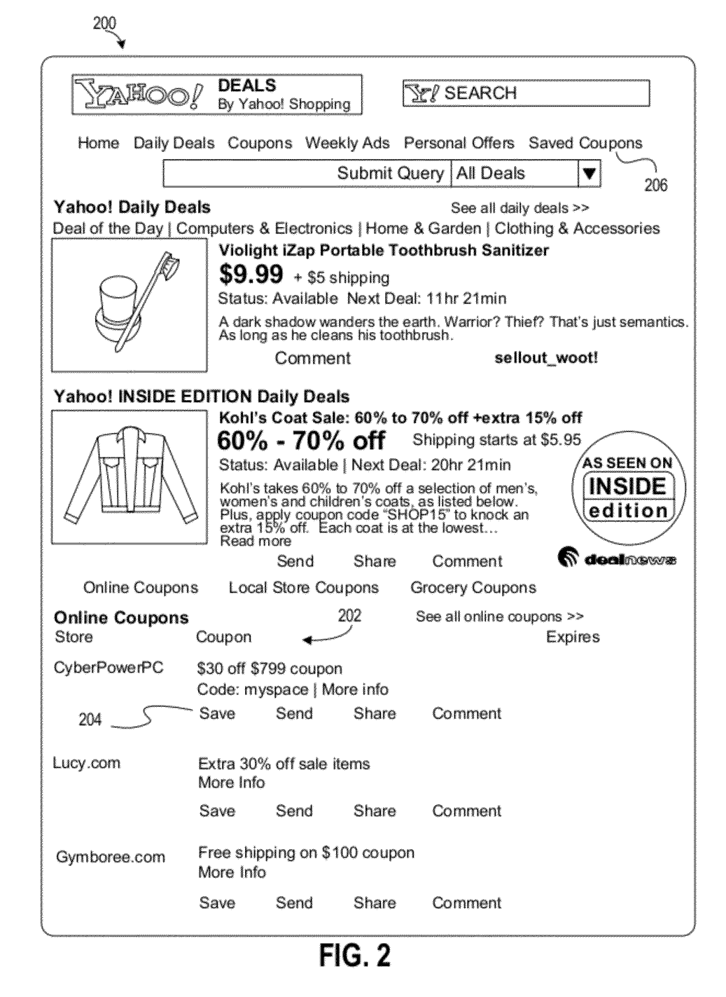

FIG. 2 illustrates coupons embedded in a Web page 200, in accordance with some embodiments. This particular Web page 200 is part of the Yahoo!™ Deals Web site. The Web page 200 allows Internet users to search for online coupons. For instance, users may search for coupons by location, category, store, etc. If an Internet user has an account at the Web portal system (e.g., Yahoo!™) that is administering the Web page 200, then the user device may initiate operations for saving within the user's account coupons presented on the Web page 200. For instance, if a user wants to save the coupon 202 for “$30 off $799” offered by CyberPower Inc., the user may select (e.g., click) the “Save” link 204. If the user chooses to save the coupon 202, then the Web portal system asks the user to log into the user account at the Web portal system. If the user does not have an account, then Web portal system asks the user to start an account at the Web portal system. Upon generation of a user account, the coupon 502 is saved in the user account managed by the Web portal system. To view the coupon, the user may click the “Saved Coupons” tab 206, which redirects the user to a Web page associated with the user account.

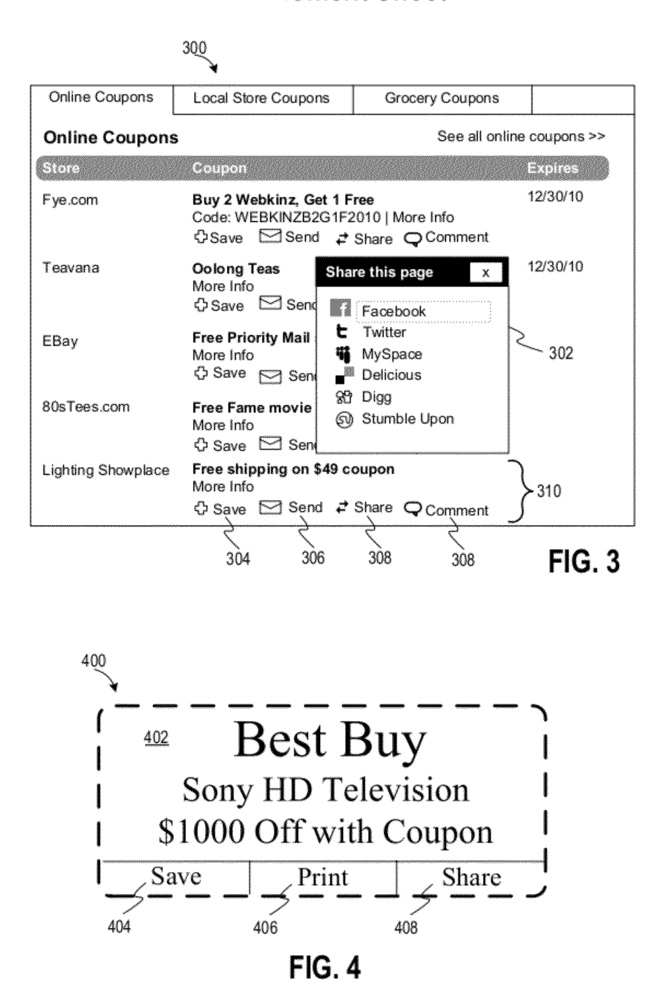

FIG. 3 shows another example of a Web page 300 that includes coupons depicted as ranked results 300, in accordance with some embodiments. The selected tab in this example is “Online Coupons.” Other tabs for selection, in this example, include “Local Store Coupons” and “Grocery Coupons.” The Web page 300 shows ranked results of ads from five advertisers, including Fye.com, Teavana, EBay, 80sTees.com, and Lighting Showplace. If an Internet user has an account at the Web portal system (e.g., Yahoo!™) that is administering the ranked results 300, then the user device may initiate an operation by selecting a hyperlink. For example, the user may select a “Save” link 304, a “Send” link 306, “Share” link 308, or a “Comment” link 308. For instance, if a user wants to save the coupon 310 for “Free shipping on $49 coupon” offered by Lighting Showplace, then the user may select (e.g., click) the “Save” link 204. The coupon will then be saved in an online account managed by the Web portal system.

In another example, the Web page 300 may provide a feature 302 for sharing all, or multiple parts, of the Web page 300. In this example, the feature 302 is a pop-up for allowing a user to initiate sharing operations on a social network site. Here, the social network sites include Facebook™, Twitter™, Myspace™, Delicious™, Digg™, and/or Stumble Upon™.

FIG. 4 shows another example of a coupon 400 in another display format, in accordance with some embodiments. An ad server retrieves the coupon 400 for display at a user device as shown. The coupon 400 provides similar functionality to the coupons in the coupon list of FIG. 3, but in a different format. In FIG. 4, the coupon 400 includes an ad body 402 having text specifying the details of the coupon offer. The coupon 400 also includes without limitation a “Save” button 404, a “Print” button 406, and/or a “Share” button 408.

Accordingly, a coupon may be displayed at a user device according to a variety of formats. For example, the ad may be formatted as embedded in a Web page (e.g., FIG. 2), part of a ranked result set in response to a query (e.g., FIG. 3), and/or part of a pop-up (e.g., FIG. 4), among other formats.

In instances where the electronic coupon file associated with the given ad 400 includes a Web link (e.g., Uniform Resource Locator link), a coupon manager device (e.g., coupon manager device 125 of FIG. 1) is configured for embedding the link within the ad body 402. As such, if a user device performs a click or otherwise selects an area within the ad body 402, the user device may be redirected to the Web page corresponding to the link. For example, clicking on the ad body 402 may redirect the user device to the Best Buy™ homepage, or to a Web page that includes additional details regarding the given coupon.

Clicking the “Save” button 404 initiates operations in the user device for saving an electronic version of the displayed coupon 400. Clicking the “Print” button 406 initiates operations in the user device for printing a copy of the coupon 400. Clicking the “Share” button 408 initiates operations in the user device for sharing the coupon 400 with another user device. For example, the user device may share the coupon via Facebook™, Twitter™, Myspace™, email, text, etc.

The ad 400 may be prepared by using a multimedia platform (e.g., Adobe Flash™). Therefore, the user device should include the necessary plug-in(s) and/or software to display the ad 400, as well as enable the functionality of each button (e.g., button 404 through button 408). If the user device lacks one or more necessary features, the Web portal system may prompt the user device to download and install the necessary browser plug-in, Java™ applet, Java™ script application, Shockwave™ component, or similar program code.

In one embodiment, when a user device performs a click on the “Save” button 404, the original coupon 400 is saved in an online user account of the Web portal system. The system may be configured such that a user device may save online coupons rendered on any Web page so long as the user device is logged into his or her account at the Web portal system. Alternatives and/or additional conditions may be imposed. For instance, the system may be configured such that a user device may only save coupons displayed on a Web page rendered by the Web portal system and/or affiliates of the Web portal system. Nonetheless, rather than requiring a user device to expend time and energy in searching for coupons using a Web site of the Web portal system, the present disclosure provides a means for dynamically serving coupons to a user device (e.g., based on user profile and/or behavior) by way of online ads.

While coupons are preferably saved in an online account, the system is not so limited. Coupons may be saved according to any suitable technique known in the art. For instance, when a user device performs a click on the “Save” button 404, a pop-up window may appear that enables the user device to save electronically the coupon in a storage area (e.g., local memory, disk, flash drive, etc.) specified by the user device. Alternatively, the coupon may be automatically saved in a predetermined cleaning medium when a user device performs a click on the “Save” button 404.

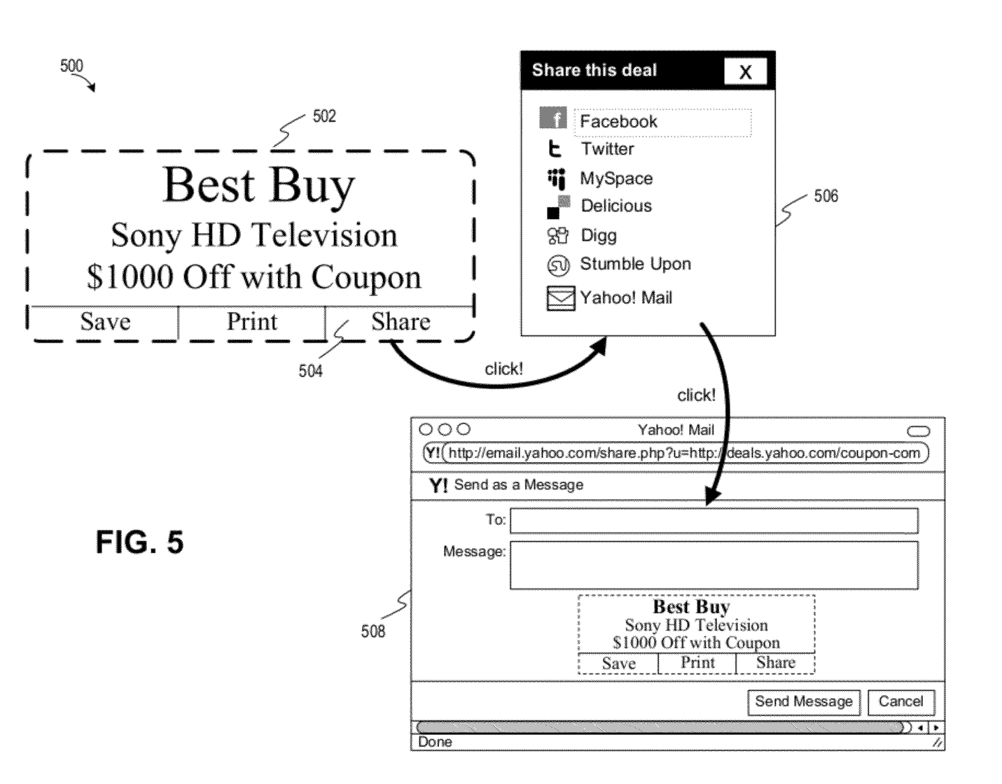

FIG. 5 is a schematic diagram of a share function 500 of a coupon 502, in accordance with some embodiments. The coupon includes without limitation a device for allowing a user to share the coupon 502. In this example, the device that allows sharing is a share button 504. Clicking the share button 504 initiates sharing functionality for the user. In this example, the sharing functionality includes without limitation a pop-up 506 that allows the user to select from among several social networks at which the user may share the coupon. In this example, the social networks include Facebook™, Twitter™, Myspace™, Delicious™, Digg™, and/or Stumble Upon™ and Yahoo!™ Mail. In this example, the user selects Yahoo! Mail. A mail window 508 is displayed that allows the referring user to email the coupon 502 to one or more referred users. As described below, the shared coupon is modified as to allow the Web portal system to track the coupon 502.

### Formatting Coupons for Tracking Referrals and Conversions

Tracking coupons allows a Web portal system (e.g., Yahoo!™) to pay users who share an ad that leads to conversion of the ad. The system is configured for tracking a coupon, not only the conversion itself, but also the one or more users involved with sharing the coupon that underwent the conversion. Accordingly, the Web portal system may share revenue from conversions with users who refer deals to friends. Encouraging users to target appropriate coupons with friends will likely result in more conversions and revenue for the Web portal system.

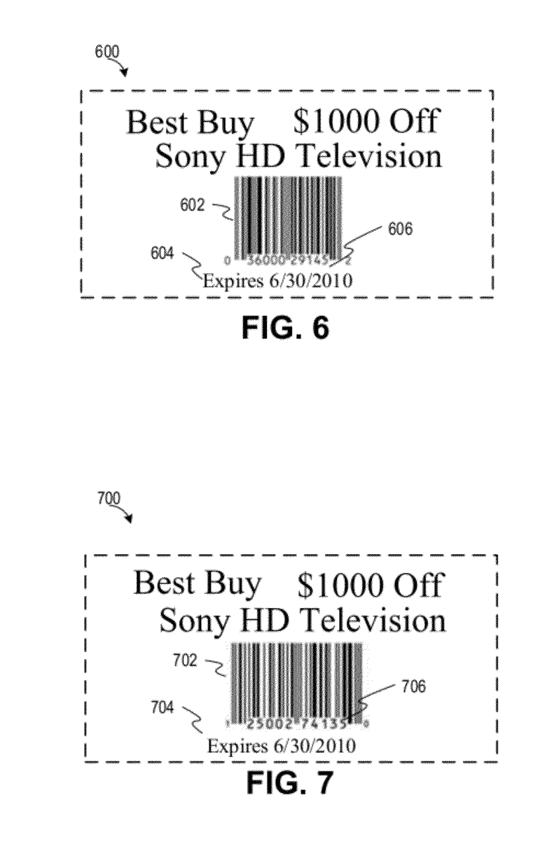

FIG. 6 shows an original coupon 600 formatted for a transaction and suitable for tracking the original coupon 600, in accordance with some embodiments. The original coupon 600 includes an expiration date 604, an identification number 606, and a unique identifier 602 (e.g., machine-readable barcode) for allowing the user device to apply the original coupon 600 to the applicable product and/or service. For example, the identifier 602 may be scanned and/or manually entered by a cashier. Accordingly, a user may use the coupon 600 without printing a physical copy, even though printing a physical copy is an option.

Alternatively, a user device may download an application operable to synchronize data between the user device and the user's online account at the Web portal system. The application may be similar to those developed for the iPhone™ and the BlackBerry™ user devices. Examples of such applications include applications developed for Facebook™ that enable users to access their Facebook™ accounts through their mobile phones.

FIG. 7 shows a shared coupon 700 formatted for a transaction and suitable for tracking the shared coupon 700, in accordance with some embodiments. The shared coupon 700 is a coupon that has an identifier 702 (e.g., unique identifier) for tracking one or more referring user, and one or more referred users. For example, the shared coupon may be the result of a user sharing the original coupon 500 of FIG. 5. In FIG. 7, the shared coupon 700 includes an expiration date 704, an identification number 706, and a unique identifier 702 (e.g., machine-readable barcode) for allowing the user to apply the shared coupon 700 to the applicable product and/or service. For example, the unique identifier 702 may be scanned and/or manually entered by a cashier. Accordingly, a user may use the shared coupon 700 without printing a physical copy, even though printing a physical copy is an option. The unique identifier 702 may include a hash that is associated with a hash record containing one or more referring users, as well as one or more referred users.

The unique identifier 702 is associated with a record of a users associated with the coupon 700. The tracking is flexible enough so that the record may include a nested hash list of one or more referring users. Conceivably, a referred user may also become a referring user. For example, user A refers the coupon to user B; user B then refers the coupon to user C. It is desirable to have the flexibility of being able to share revenue with both user A and user B. Thus, revenue for a single conversion may be shared with more than one referrer (e.g., user A and user B).

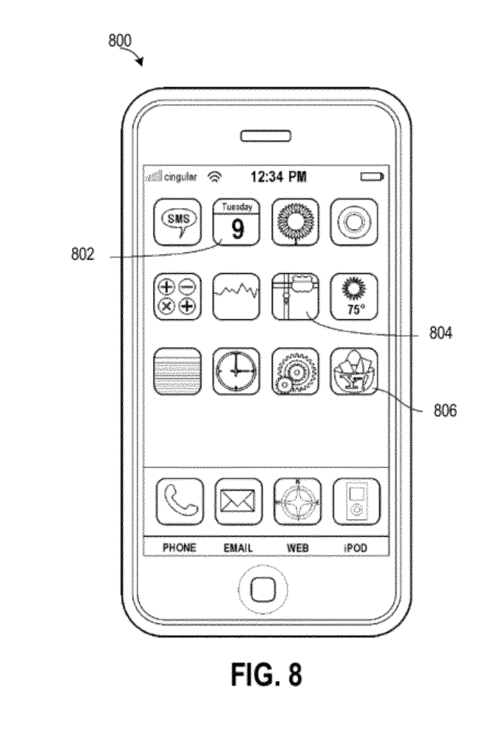

FIG. 8 is an example user device 800 that is displaying icons for applications of a Web portal system, in accordance with some embodiments. In this example, the user device 800 is an iPhone™ that is displaying, among other things, icons for a coupons application 806 (e.g., Yahoo!™ Coupons application), a map application 804 and a calendar application 802. Opening the coupons application 806 (e.g., by touching the Yahoo!™ Deals icon) causes a coupons interface to be displayed.

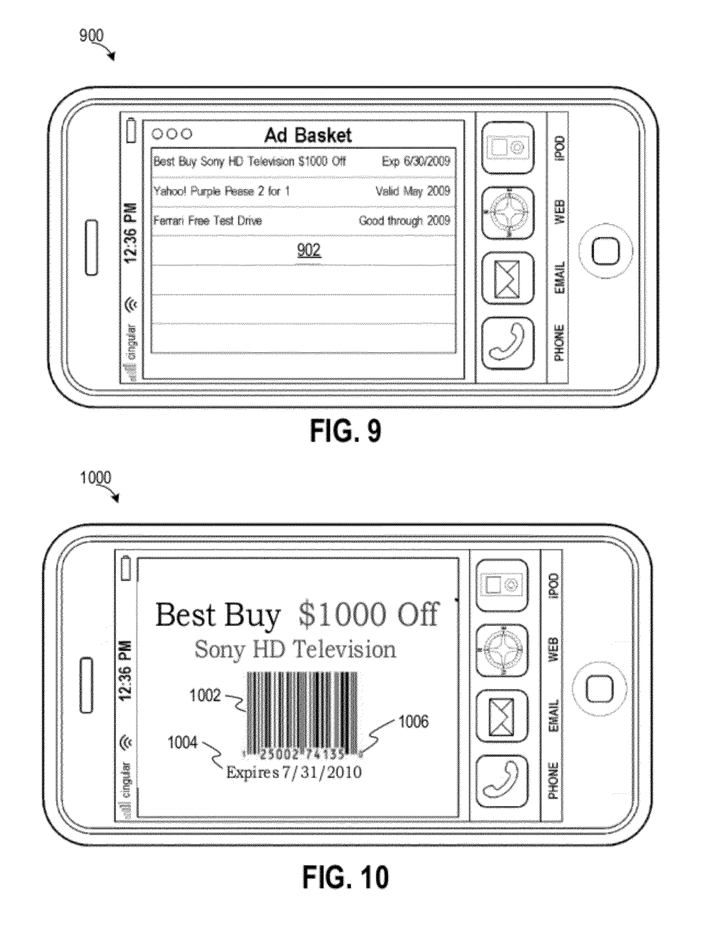

FIG. 9 is an example user device 900 that is displaying an interface 902 for a coupons application of a Web portal system, in accordance with some embodiments. In this example, the interface 902 is that of a Yahoo!™ Coupons application for an iPhone™. The interface 902 includes a coupon organizer application (e.g., “Ad Basket”) that lists all coupons saved by the user device 900 in the user's Web portal account. If a user selects an original coupon in the “Ad Basket”, the original coupon is, for example, displayed on the screen of the iPhone™.

FIG. 10 is an example user device 1000 that is displaying a coupon, in accordance with some embodiments. In this example, the user device 1000 is an iPhone™ that is displaying a shared coupon that is in a format that is suitable for tracking. The shared coupon may be redeemed, for example, by scanning a barcode 1002 or by manually entering a barcode number 1006. The barcode 1002 may include a hash that is associated with a hash record containing one or more referring users, as well as one or more referred users. The coupon has an expiration date 1004.

A coupons application (e.g., a Yahoo!™ Coupons application) may include a wide range of additional functions. For instance, a Web portal application may include functionality for integrating a coupon with other applications installed on the user device. In one aspect, the Web portal application is operable to supply the expiration date to a calendar application, wherein the user device may be configured for generating one or more reminders as the coupon nears its expiration date.

Referring again to FIG. 9, a coupons application may allow a user device 900 to delete one or more coupons from the interface 902 (e.g., the “Ad Basket”). Because the user device 900 is synchronized with the user's Web portal account, any deleted coupons would therefore be deleted from the Web portal account. Similarly, if a user device 900 deletes a coupon from the associated Web portal account by accessing the one or more networks via a separate user device (e.g., personal computer), the coupon will be deleted from the interface 902 (e.g., “Ad Basket”). The interface 902 may be updated at predetermined time intervals, automatically, and/or manually (e.g., the coupons application may include a “refresh” button). In addition, if a saved coupon is redeemed and/or expired, the coupon may be automatically rendered invalid and/or deleted from the user's Web portal account.

Referring again to FIG. 8, the Web portal application may include a search function for allowing the user device 800 to search for online coupons offered by businesses within close proximity. For instance, the map application 804 may determine a user's current location by using a global positioning system (GPS). In response to a search request, the coupons application 806 may return a list of hyperlinks pertaining to businesses closest to the user device 800. If the user device 800 performs a click on a hyperlink, the user device 800 may be redirected to a list of online coupons associated with the business that is advertising.

The search function may sort online coupons based on a summed evaluation of radial distance from the user, online reviews of the business and/or the products/services offered by the business, prices associated with the advertised products/service, etc. By way of example, search results may be ordered based on a weighted average aggregated from information that may be obtained from, for example, a Web portal site (e.g., www.yahoo.com), a mapping Web site (e.g., www.maps.yahoo.com) and/or a local Web site (e.g., www.local.yahoo.com). In some embodiments, the search function utilizes an aggregation equation such as the following equation:

Σwᵢ×qᵢ Equation 1.

In Equation 1, i is an integer; q is a quantity indicative of radial distance, online ratings, coupons, deals, prices, etc.; and w is a weight in inverse q units.

The Web portal system and/or advertisers may track certain conversions associated with the online ads in order to generate data and performance reports. Such conversions may include information about a coupon being redeemed, saved, printed, deleted, sent, shared, and/or commented on. The Web portal system and/or advertisers may utilize the foregoing information to improve ad targeting.

### Paving Users to Share Coupons

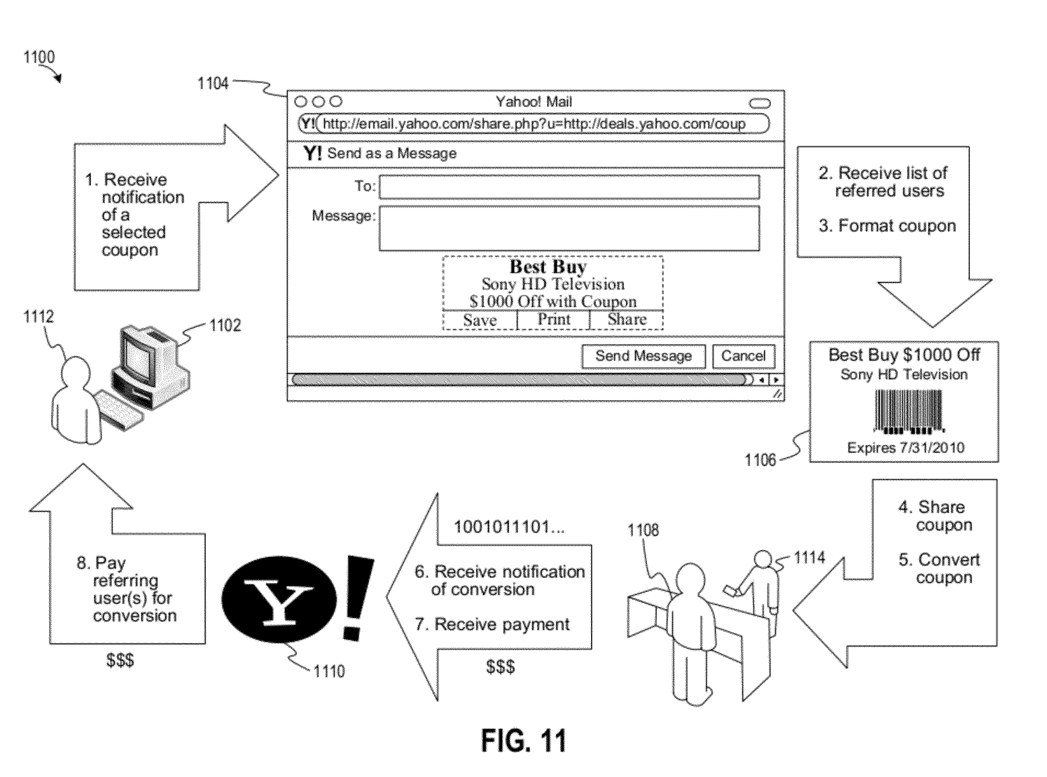

FIG. 11 is a schematic diagram of a system 1100 for paying users to share coupons, in accordance with some embodiments. The system 1100 (e.g., Yahoo!™) provides one or more coupons to a user 1112. The user 1112 selects a coupon for sharing. The system 1100 receives a notification of the coupon selected for sharing.

When a user engages the share functionality, the system 1100 preferably provides information to the appropriate user device about how to get paid for sharing the coupon with other users. For example, a pop-up (not shown) may be displayed that says something like, “Earn money by sharing deals; Click here to learn more.” The user clicks on the pop-up and learns how sharing ads can earn the user money. Further, the user follows any instructions, like setting up an online bank account (e.g., PayPal account), which allows the user to collect money earned from sharing ads that underwent conversions.

An interface 1104 is displayed that allows the user 1112 to share the coupon with other users. For example, the user may input one or more email addresses and click send. The word ‘Sent!’ may appear briefly and then the interface 1104 (e.g., share pop-up) closes. The system 1100 receives the list of one or more referred users.

The system 1100 formats the coupon for tracking purposes. The coupon 1106 is in a format that is suitable for tracking one or more referring users, as well as one or more referred users. The user 1112 is an example of a referring user. The coupon may be shared with various users and tracked accordingly.

The system 1100 sends the coupon 1106 to one or more referred users. For example, one or more friends of the referring user 1112 may receive the coupon 1106 via email. The one or more referred users may print, save, and/or share the coupon.

A referred user 1114 may decide to convert the coupon. For example, the referred user 1114 may use the coupon 1106 at a retail outlet (e.g., Best Buy™) by purchasing the advertised product and/or service. In the process of completing the transaction, the seller may scan the coupon or manually input a unique identifier for the coupon. Information describing the transaction is saved in the seller's database.

The system 1100 receives notification of the conversion. For example, the seller sends the scanned or manually inputted information to the system administrator (e.g., Yahoo!™). The system gathers information for the coupon within periodic aggregations of conversions. For example, the conversions may be aggregated hourly, daily and/or monthly.

The system 1100 pays one or more referring users for the conversion. For example, the system 1100 may transfer payment to bank accounts (e.g., PayPal™ accounts) that are linked to user accounts of the referring users.

The information associated with the converted ad may also be used to determine better targeting of ads for the users identified in the conversion. For example, better targeting may be provided for the referring users and/or the referred user (e.g., the buyer who converted the coupon).

The revenue to be shared will come from advertisers. For example, a coupon for $10 off of an oil change might actually cost the advertiser $11, where $1 is reserved for revenue sharing with referrers. As more statistics are gathered as to how many deals get referred, it will be easier for advertisers to budget for revenue sharing with referrers.

Ad developers who make the coupon creatives will be able to add or subtract sharing functionality (e.g., a “Share” button). If an advertiser does not want to participate in revenue sharing with referrers, then it will be easy to deliver their creatives without the sharing functionality.

### Avoiding Abuse of the Sharing System

When users understand that money can be made from referring good deals to their friends, unfortunately, users may develop a strategy for spamming other users with coupons carrying the identity of the spammer. Further, if mutually acquainted users want to take advantage of a deal, it would be in their best interest to refer each other to the deal rather than individually and separately taking advantage of the deal.

To mitigate such abuse, this system 1100 may be configured with one or more safeguards. The system may employ one or more spam filters. Spam filters would likely prevent unwanted mailings from unknown referrers. The system's spam filters may be updated to filter out more accurately unwanted referrals. The system may also be configured for limiting referrals to one hop. For example, the system may deliver referred coupons without the share functionality, so that the coupon can be referred only once or only a designated number of times.

### Marketability of the Sharing System

Sharing a coupon should be as easy as possible for users. If users share ads they find useful with other users whom they expect to also appreciate these ads, then the system 1100 has improved targeting users who may not have otherwise received these ads.

Users should have an incentive to motivate other users (e.g., friends) to execute conversions for offline transactions. All four parties involved in a referred deal should benefit from the conversion. For example, the seller benefits by selling more products and/or services. The system administrator (e.g., Yahoo!™) benefits from the conversion, both in terms of revenue and data useful for better targeting users. The referred user (e.g., friend) benefits from the deal they took advantage of with the seller via the coupon forwarded to them by the referring user. The referring user benefits from revenue sharing in the value attached to the conversion.

### Overview of Method for Sharing Online Coupons

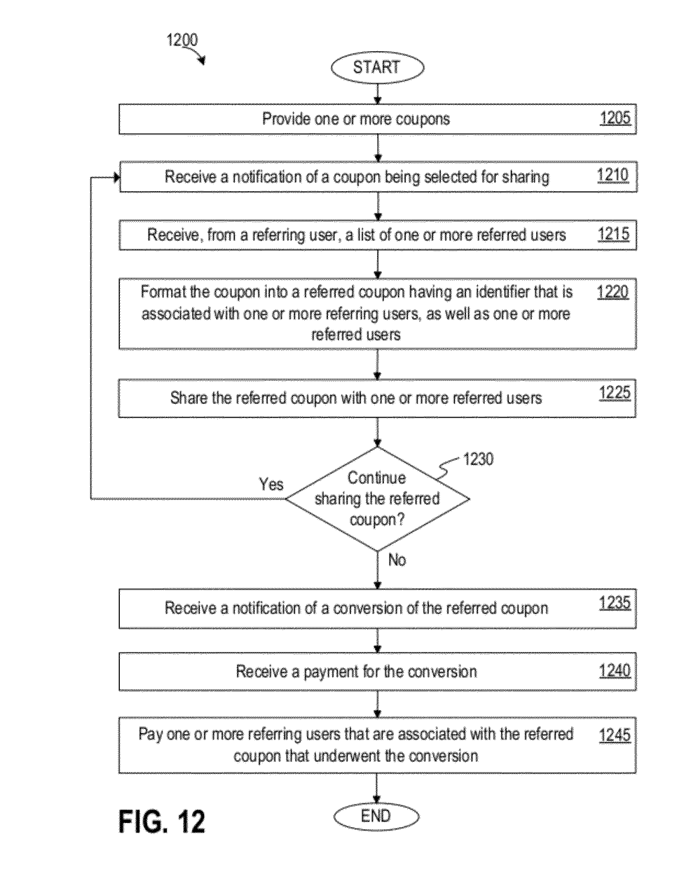

FIG. 12 is a flowchart of a method 1200 for sharing online coupons, in accordance with some embodiments. The steps of the method 1200 may be carried out by one or more devices of the system 100 shown in FIG. 1.

The method 1200 starts in a step 1205 where the system provides one or more coupons to a user device. The method 1200 moves to a step 1210 where the system receives a notification of a coupon being selected for sharing. The method 1200 proceeds to a step 1215 where the system receives, from a referring user, a list of one or more referred users. Next, in a step 1220, the system formats the coupon into a referred coupon having an identifier that is associated with one or more referring users and one or more referred users. The method 1200 then moves to a step 1225 where the system shares the referred coupon with one or more referred users.

Then, in a decision operation 1230, the system determines if sharing of the referred coupon is continuing. If sharing is continuing, then the method 1200 returns to the step 1210 where the system receives a notification of a coupon being selected for sharing.

However, if the system determines in decision operation 1230 that sharing is not continuing, then the system 1200 proceeds to a step 1235 where the system receives notification of a conversion of the referred coupon. Next, in a step 1240, the system receives a payment for the conversion. The method 1200 then moves to a step 1245 where the system pays one or more referring users that are associated with the referred coupon that underwent the conversion. The method 1200 concludes after the step 1245.

Note that the method 1200 may include other details and steps that are not discussed in this method overview. Other details and steps are discussed with reference to the appropriate figures and may be a part of the method 1200, depending on the embodiment.

### Exemplary Network, Client, Server and Computer Environments

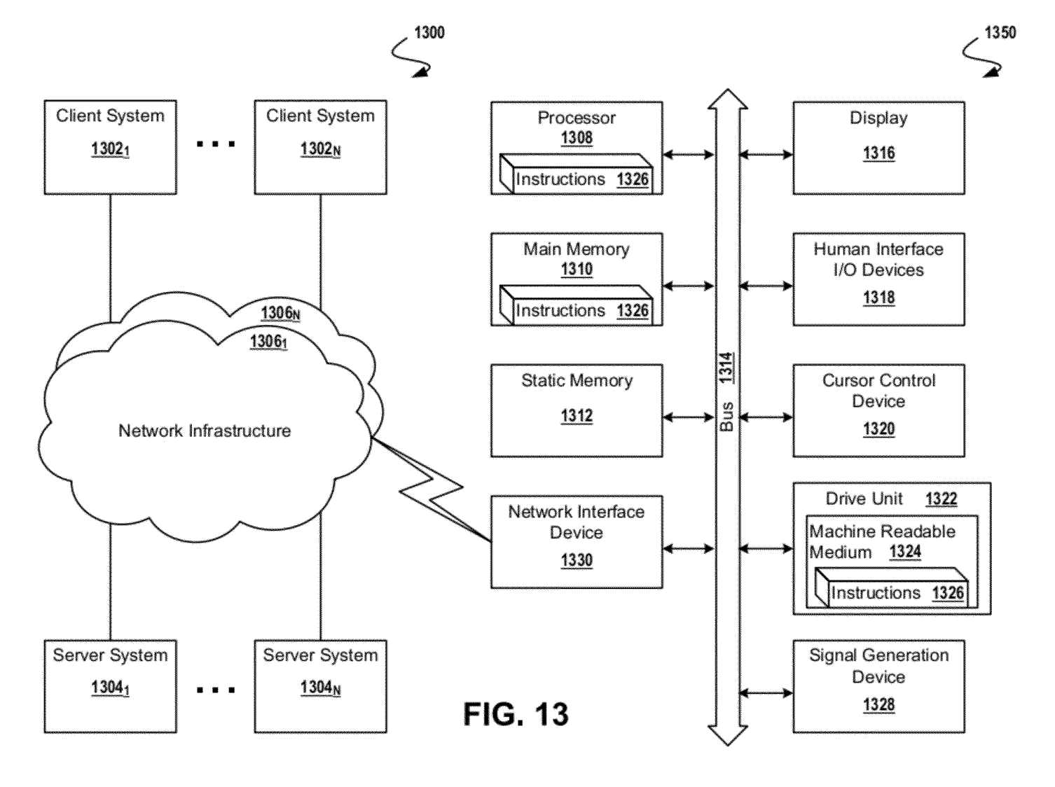

FIG. 13 is a diagrammatic representation of a network 1300, including nodes for client systems 1302₁ through 1302_{N}, nodes for server systems 1304₁ through 1304_{N}, nodes for network infrastructure 1306₁ through 1306_{N}, any of which nodes may comprise a machine 1350 within which a set of instructions, for causing the machine to perform any one of the techniques discussed above, may be executed. The embodiment shown is exemplary, and may be implemented in the context of one or more of the Figures herein.

Any node of the network 1300 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a Web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g., a client computer system, a server computer system) and/or may comprise one or more embedded computer systems, a massively parallel computer system, and/or a cloud computer system.

The computer system 1350 includes a processor 1308 (e.g., a processor core, a microprocessor, a computing device, etc.), a main memory 1310 and a static memory 1312, which communicate with each other via a bus 1314. The machine 1350 may further include a display unit 1316 that may comprise a touch-screen, or a liquid crystal display (LCD), or a light emitting diode (LED) display, or a cathode ray tube (CRT). As shown, the computer system 1350 also includes a human input/output (I/O) device 1318 (e.g. a keyboard, an alphanumeric keypad, etc), a pointing device 1320 (e.g., a mouse, a touch screen, etc), a drive unit 1322 (e.g., a disk drive unit, a CD/DVD drive, a tangible computer readable removable media drive, an SSD storage device, etc.), a signal generation device 1328 (e.g., a speaker, an audio output, etc.), and a network interface device 1330 (e.g., an Ethernet interface, a wired network interface, a wireless network interface, a propagated signal interface, etc.).

The drive unit 1322 includes a machine-readable medium 1324 on which is stored a set of instructions 1326 (e.g., software, firmware, middleware, etc.) embodying any one, or all, of the methodologies described above. The set of instructions 1326 is also shown to reside, completely or at least partially, within the main memory 1310 and/or within the processor 1308. The set of instructions 1326 may further be transmitted or received via the network interface device 1330 over the network bus 1314.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; electrical, optical or acoustical or any other type of media suitable for storing information.

### Advantages

Embodiments of the system described above add sharing functionality to online coupons that allow a user to share a coupon offer with a friend. The sharing functionality motivates users to share deals because referring users are paid for a conversion of a coupon. The system naturally delivers better targeted ads via the referrals, thereby increasing the likelihood of realized conversions.

Conversions are several orders of magnitude more valuable than impressions. Advertisers are beginning to place a higher value on return on investment for display advertisements. The tracking operations of the system allow for improved ways of quantifying return on investment for display advertisements.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A computer-implemented method for sharing coupons, the method comprising:
providing, to a user device, one or more coupons that each include functionality for performing a sharing operation;
receiving, at a computer, notification of a coupon being selected for sharing, wherein the notification is a result of a user selecting a sharing operation in the coupon;
receiving, from a referring user, a list of one or more referred users, wherein the list of one or more referred users includes users with which the referring user intends to share a coupon;
formatting the coupon into a referred coupon having an identifier that is associated with one or more referring users, as well as one or more referred users; and
sharing the referred coupon with one or more referred users.

2. The method of claim 1, further comprising sharing the referred coupon with one or more additional referred users.

3. The method of claim 1, further comprising receiving a notification of a conversion of the referred coupon, wherein the conversion is a purchase that happens as a result of a referred user responding to a coupon.

4. The method of claim 3, further comprising receiving a payment from a seller for the conversion of the referred coupon.

5. The method of claim 3, further comprising paying one or more users that are associated with the referred coupon that underwent the conversion.

6. The method of claim 1, wherein each of the one or more coupons further includes functionality for performing at least one of:
a sending operation;
a printing operation;
a saving operation; and
a commenting operation.

7. The method of claim 1, wherein the identifier for the referred coupon includes at least one of:
a unique identifier; and
a machine-readable barcode.

8. The method of claim 1, further comprising providing information to a user device about how to get paid for sharing a coupon with other users.

9. The method of claim 1, further comprising providing functionality that allows a user to share a coupon by using at least one of:
email; and
a social network, including a networked software application having user accounts that are coupled by using one or more interdependencies.

10. The method of claim 1, further comprising gathering information for the referred coupon within periodic aggregations of conversions.

11. A system for sharing coupons, the system comprising:
a computer system configured for:
providing, to a user device, one or more coupons that each include functionality for performing a sharing operation;
receiving, at a computer, notification of a coupon being selected for sharing, wherein the notification is a result of a user selecting a sharing operation in the coupon;
receiving, from a referring user, a list of one or more referred users, wherein the list of one or more referred users includes users with which the referring user intends to share a coupon;
formatting the coupon into a referred coupon having an identifier that is associated with one or more referring users, as well as one or more referred users; and
sharing the referred coupon with one or more referred users.

12. The system of claim 11, wherein the computer system is further configured for sharing the referred coupon with one or more additional referred users.

13. The system of claim 11, wherein the computer system is further configured for receiving a notification of a conversion of the referred coupon, wherein the conversion is a purchase that happens as a result of a referred user responding to a coupon.

14. The system of claim 13, wherein the computer system is further configured for receiving a payment from a seller for the conversion of the referred coupon.

15. The system of claim 13, wherein the computer system is further configured for paying one or more users that are associated with the referred coupon that underwent the conversion.

16. The system of claim 11, wherein each of the one or more coupons further includes functionality for performing at least one of:
a sending operation;
a printing operation;
a saving operation; and
a commenting operation.

17. The system of claim 11, wherein the identifier for the referred coupon includes at least one of:
a unique identifier; and
a machine-readable barcode.

18. The system of claim 11, wherein the computer system is further configured for providing information to a user device about how to get paid for sharing a coupon with other users.

19. The system of claim 11, wherein the computer system is further configured for providing functionality that allows a user to share a coupon by using at least one of:
email; and
a social network, including a networked software application having user accounts that are coupled by using one or more interdependencies.

20. The system of claim 11, wherein the computer system is further configured for gathering information for the referred coupon within periodic aggregations of conversions.

21. A computer readable medium comprising one or more instructions for sharing coupons, wherein the one or more instructions are configured for causing one or more processors to perform the steps of:
providing, to a user device, one or more coupons that each include functionality for performing a sharing operation;
receiving, at a computer, notification of a coupon being selected for sharing, wherein the notification is a result of a user selecting a sharing operation in the coupon;
receiving, from a referring user, a list of one or more referred users, wherein the list of one or more referred users includes users with which the referring user intends to share a coupon;
formatting the coupon into a referred coupon having an identifier that is associated with one or more referring users, as well as one or more referred users; and
sharing the referred coupon with one or more referred users.
